(19) United States
(12) Patent Application Publication
(10) Pub. No.: US 2024/0229174 A9
(43) Pub. Date: Jul. 11, 2024

(54) Method of manufacturing steel

(71) Applicant: ArcelorMittal, Luxembourg (LU)

(72) Inventors: Hugo DA GAMA CAMPOS, London (GB); Jean-Martin VAN DER HOEVEN, Luxembourg (LU)

(21) Appl. No.: 18/278,022

(22) PCT Filed: Feb. 23, 2022
(86) PCT No.: PCT/IB2022/051594

§ 371 Date: Aug. 21, 2023

(30) Foreign Application Priority Data
Feb. 26, 2021 (WO) PCT/IB2021/051607

(51) Int. Cl. C21C 5/46; C21B 5/00; C21B 5/06; C21B 13/00; C21C 5/38; C21C 5/52

(52) U.S. Cl. CPC C21C 5/4673; C21B 5/006; C21B 5/008; C21B 5/06; C21B 13/0073; C21C 5/38; C21C 5/462; C21C 5/527; C21B 2300/04; C21C 2100/02; C21C 2300/06

(57) ABSTRACT

A method to manufacture a global tonnage of steel products in at least two steelmaking units wherein expected level emissions are calculated and compared with pre-defined targets.

The invention is related to a method of manufacturing steel.

### BACKGROUND

The steel industry, like many other human activities, is a source of CO2 emission in the atmosphere. Many technologies are implemented or under development to decrease those CO2 emissions at different levels of the production, through for example recycling of blast furnace, coke oven or converter top gas. This recycling may be performed, after appropriate treatments, by injection into another steelmaking device or use as syngas for other productions.

These technologies aim to decrease direct CO2 emissions of the manufacturing of steel products.

### SUMMARY OF THE INVENTION

However, customers of such steel products, such as car makers, also have to reduce the carbon footprint of their products and to do so request steel products fulfilling all their usual standards in terms of physical properties and quality, but also in terms of carbon footprint. This CO2 carbon footprint is not limited to the direct emissions of the manufacturing process itself.

There is so a need for a method allowing to determine and reduce the CO2 footprint of steel products.

The present invention provides a method wherein a given tonnage of steel products is to be manufactured in at least two steelmaking units, the method including a target definition step wherein an overall expected level of CO2 emissions from all steelmaking units to manufacture such tonnage of steel products is defined, a maximum level of CO2 emissions is predefined for each steelmaking unit, a calculation step wherein an expected level of CO2 emissions is calculated for each steelmaking unit, such calculation being done considering all CO2 contributions linked to raw materials, energy sources and processes initially selected for manufacturing the steel products following an initial manufacturing route, a comparison step between respective calculated expected levels and predefined targets, wherein if any or all expected emissions is above its respective maximum level, modifying the final selection of any or all the raw materials, energy sources and processes to define an optimized manufacturing route with optimized levels of CO2 emissions, optimized level being lower than or equal to maximum level, and a production step wherein the tonnage of steel products is manufactured in the steelmaking units according either the original manufacturing or the optimized manufacturing route when defined.

The method of the invention may also comprise the following optional characteristics considered separately or according to all possible technical combinations:
a first steel product is manufactured in the first steelmaking unit and then send to the second steelmaking unit to be transformed into a second steel product,
finally selected raw material are chosen among coal, coke, iron ore, biomass, sintered ore, agglomerates, pellets, direct-reduced iron (DRI), scrap, mineral additions, alloying elements, oxygen or hydrogen,
finally selected raw material are chosen among biomass, scrap, cold-bonded pellets, direct-reduced iron (DRI), mineral additions, alloying elements, oxygen or hydrogen,
scrap is of different type and is chosen among old scrap, new scrap, prime scrap, home scrap, pit scrap, shredded, plates and structure scrap, heavy melting scrap, cast scrap, coil scrap or busheling scrap,
finally selected energy sources are chosen among renewable electricity, electricity produced by internal recycling of exhaust gas from the steel manufacturing process or by capture of heat released by products from the steel manufacturing process,
finally selected processes are chosen among direct reduction processes, hydrogen-based ironmaking, steel electrolysis, blast furnace with top-gas recycling, blast furnace with top-gas conversion, electric-arc-furnace steelmaking, converter steelmaking, scrap melting,
the method further includes a step, after the production step, of establishing a certificate indicating the optimized level of CO2 emissions associated to part or all of the tonnage of manufactured steel products,
the method further includes a step, after the production step, of first calculating the cumulated value of CO2 emitted in manufacturing step of all steelmaking units for manufacturing the tonnage of steel products, then calculating the difference between such cumulated value and the overall expected amount of CO2 emissions for said tonnage of steel products as defined in first target definition step to determine the amount of CO2 that was not emitted, allocating all or part of this not-emitted amount of CO2 to a green tonnage of steel products, said green tonnage being lower than the global tonnage, to calculate a reduced level of CO2 emissions for such green tonnage of steel products by reducing the expected level of CO2 emissions triggered by its manufacturing by such not-emitted amount of CO2, and establishing a certificate indicating said reduced level of CO2 emissions associated to such green tonnage of steel products,
the reduced level of CO2 emissions associated to the green tonnage of steel products is equal to zero.

### BRIEF DESCRIPTION OF THE DRAWINGS

Other characteristics and advantages of the invention will emerge clearly from the description of it that is given below by way of an indication and which is in no way restrictive, with reference to the appended FIGURES in which:

FIG. 1 is a flowchart of a method, according to the invention, for manufacturing steel

### DETAILED DESCRIPTION

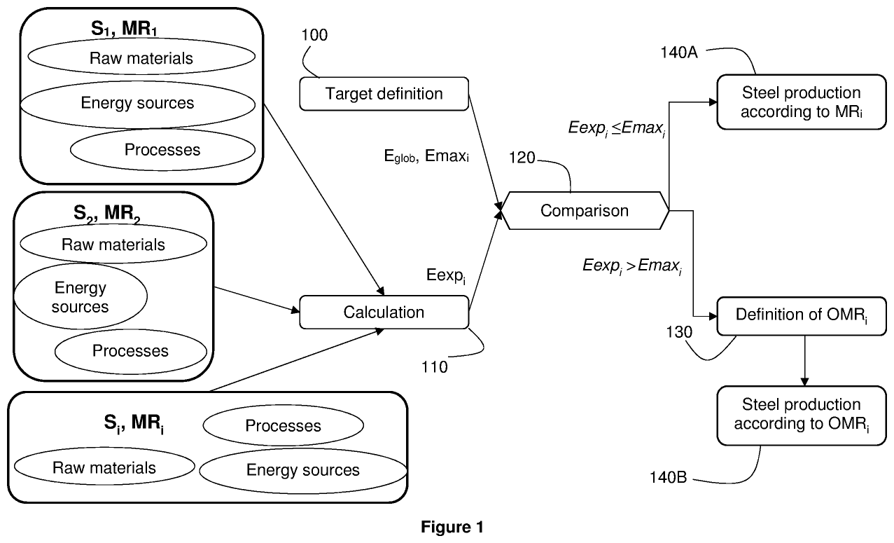

FIG. 1 represents a flowchart of a method to manufacture steel products according to the invention. The manufacturing of a given tonnage T_{glob} of steel products is performed in at least two steelmaking units Sᵢ. The steel product may be chosen among liquid steel, steel semi-product, steel flat product, steel long product. Among steel flat product, it may be a slab, a hot-rolled coil, a cold-rolled coil, a sheet, a plate. Among long products, it may be a hot rolled, cold rolled or drawn bar, rebar, railway rails, wire, rope, sections such as U, I, or H section beam, a sheet pile, a bloom, a billet.

By steelmaking unit it is meant a unit comprising all necessary manufacturing tools allowing to produce the considered steel product. A manufacturing tool maybe a combination of several pieces of equipment. For example, a blast furnace with top-gas recycling is one tool, even if it comprises a blast furnace, gas treatment devices and gas heating devices. The tools may be chosen among a coking plant, a sintering plant, a direct-reduction plant, a blast-furnace, an electric-arc furnace, a converter, a ladle, a H2 production plant, a chemical plant, a biotech plant, a power plant, a furnace, a casting plant, a rolling plant, gas cleaning devices, heat recovery devices, hot stoves, coating devices.

As a matter of illustration if the considered product is a liquid steel the first steelmaking unit S1 may comprise a blast furnace, a basic oxygen furnace and a ladle furnace. The steelmaking unit S2 may comprise a direct-reduction plant, an electric-arc furnace and a ladle furnace.

In a first step 100, two targets are defined: an overall expected level E_{glob} of CO2 emissions from all steelmaking units Sᵢ to manufacture the tonnage T_{glob} of steel products and a maximum level of CO₂ emissions Emaxᵢ for each steelmaking unit Si.

Those targets may be defined taking into account different parameters such as local regulations, CO2 already emitted for previous production campaigns, state of the different production equipment or availability of renewable energies.

In a second step 110, which can be either performed after or in parallel to the first step 100, a calculation step is performed wherein an expected level of CO₂ emissions Eexpᵢ is calculated for each steelmaking unit Si. This calculation 110 is done considering all CO2 contributions linked to raw materials, energy sources and processes initially selected for manufacturing the steel products for manufacturing the steel products according to an initial manufacturing route Ri.

Raw materials may be of different types. They may include coal, coke, iron ore, biomass, sintered ore, agglomerates, pellets, direct-reduced iron (DRI), scrap, mineral additions, such as limestone or dolomite, alloying elements but also gases such as oxygen or hydrogen. Scrap maybe of different typologies among, notably, old scrap, new scrap, prime scrap, home scrap, pit scrap, shredded, plates and structure scrap, heavy melting scrap, cast scrap, coil scrap or busheling scrap.

Plate and structural scrap, often referred to as P&S in the scrap industry, is a cut grade of ferrous scrap, presumed to be free of any contaminates. Plate and structural scrap comprise clean open-hearth steel plates, structural shapes, crop ends, shearing, or broken steel tires. Heavy melting steel (HMS) or heavy melting scrap is a designation for recyclable steel and wrought iron. It is broken up into two major categories: HMS 1 and HMS 2, where HMS 1 does not contain galvanized and blackened steel, whereas HMS 2 does. Both HMS 1 and 2 comprise iron and steel recovered from items demolished or dismantled at the end of their life. Pit scrap is a by-product of flat steel products manufacturing process containing merely scale. Coil scrap contains discarded coils, because of quality issues by example, or residues of coil cutting. Cast Iron Scrap is an alloy of iron that contains high amounts of carbon. The carbon content makes it susceptible to corrosion. As a result, Cast Iron scrap is often rusted and worn. Cast iron scrap can be obtained from heating systems, vehicle components etc. Another kind is busheling scrap constituted of clean steel scrap and include new factory busheling (for example, sheet clippings, stampings, etc.).

By considering all CO2 contributions linked to raw materials, it is meant that all CO2 emissions linked to the production of those raw materials before they are used into the steel manufacturing process is taken into account. For example, when considering iron ore, all CO2 emissions related to the mining extractions and ore processing have to be included into the calculation. Same for the scrap, even it is the recycling of an existing product, it has a CO2 footprint coming from its former life which has to be considered into the calculation. Depending on its typology, CO2 footprint may differ from one scrap to another.

Energy sources may also be various. They include electricity coming from renewable energy, such as from solar panels or windmills, but also electricity produced by power plant, which may use gases resulting from the steelmaking process, such as blast furnace gases or converter gases. It also includes any fuel, either gaseous or solid, fossil or organic, which may be used into the steel manufacturing process.

In order the calculation to be the most accurate it is important to not count a CO2 impact twice. For example, if coke is considered as a raw material to the converter process and its impact included into the raw materials impact, it must not be considered as a fossil fuel and included into the energy sources impact.

Processes include all different processes performed along the manufacturing route MRᵢ and their associated CO₂ emissions. It includes pig iron production, liquid steel production and finishing processes. Pig iron production includes coking, sintering, pelletizing, blast furnace process, but also direct reduction and shaft furnace processes. Liquid steel production covers decarburization, dephosphorization and all secondary metallurgy or ladle treatments allowing to turn pig iron into liquid steel and adjust the composition of the liquid steel for further steps, it also includes the electric-arc-furnace steelmaking process. Finishing processes include notably casting, heating, rolling, cooling, coiling, shaping, levelling, welding, coating. When considering CO₂ impact of a process, all by-products recycling or emission reduction technologies applied to said process has to be taken into account for the calculation. For example, blast furnace process without top-gas recycling does not have the same CO₂ impact as the same blast furnace process wherein top-gas is not released to the atmosphere but rather re-injected into.

Once this expected level of CO₂ emissions Eexpᵢ is calculated, it is used into a comparison step 120 where it is compared with its respective predefined target emissions level Emaxᵢ. If any or all Emxpᵢ is above its respective Emaxᵢ, then an optimized manufacturing route OMRᵢ with optimized levels of CO₂ emissions Eoptimᵢ, is defined by modifying the final selection of any or all of the raw materials, energy sources and processes so that Eoptimᵢ is lower than or equal to Emaxᵢ. As a matter of example, for a given steelmaking unit S₁, if the original manufacturing route MR₁ uses coal as raw material in a blast furnace, the optimized manufacturing route OMR₁, may replace this coal by torrefied biomass so as to reduce the CO2 emissions.

In the final selection raw materials are preferentially chosen among biomass, scrap, cold-bonded pellets, direct-reduced iron (DRI), mineral additions, alloying elements, oxygen or hydrogen. Finally selected energy sources are preferentially chosen among renewable electricity, electricity produced by internal recycling of exhaust gas from the steel manufacturing process or by capture of heat released by products from the steel manufacturing process. Finally selected processes are preferentially chosen among direct reduction processes, hydrogen-based ironmaking, steel electrolysis, blast furnace with top-gas recycling, blast furnace with top-gas conversion, electric-arc-furnace steelmaking, converter steelmaking, scrap melting. By hydrogen-based ironmaking it is meant any ironmaking process, such as a direct-reduction process or a blast-furnace process wherein the reducing gas is mainly composed of hydrogen, it encompasses also blast furnace with coke-oven gas injection. Blast-furnace with top-gas recycling means a blast furnace process wherein top-gas exhausting from the blast furnace is at least partly re-injected into the blast furnace after appropriate treatments. Blast furnace with top-gas conversion means a blast furnace process wherein top-gas exhausting from the blast furnace is at least partly used to produce a syngas which is then further used in chemical, biochemical or power plants.

Then in a last step 140A, 140B, the tonnage T_{glob} of steel products is manufactured in each steelmaking plant Sᵢ either 140A according to the original manufacturing route MRᵢ or 140B according to the optimized manufacturing route OMRᵢ.

In a first embodiment, after the production step, an additional is performed which consists in establishing a certificate indicating the optimized level Eoptimᵢ of CO2 emissions associated to part or all of the tonnage T_{glob} of manufactured steel products.

In another embodiment, another step may be performed after the production step which consists in first, calculating the cumulated value Σ(Eoptimᵢ) of CO2 emitted in the production step by all steelmaking units Sᵢ for manufacturing the tonnage T_{glob} of steel products, then calculating the difference Δₑₘ between such cumulated value Σ(Eoptimᵢ) and the overall expected amount E_{glob} of CO2 emissions for said tonnage T_{glob} of steel products as defined in the targets definition step 100 to determine the amount Eₙₒₜ of CO2 that was not emitted, allocating all or part of this not-emitted amount Eₙₒₜ of CO2 to a tonnage T_{green} of steel products, T_{green} being lower than T_{glob}, to calculate a reduced level of CO2 emissions for such tonnage T_{green} of steel products by reducing the expected level of CO2 emissions triggered by its manufacturing by such not-emitted amount of CO2, and finally establishing a certificate indicating said reduced level of CO2 emissions associated to such tonnage T_{green} of steel products.

In a preferred embodiment, the reduced level of CO2 emissions associated to the tonnage T_{green} of steel products is equal to zero

With the method according to the invention it is possible to determine and reduce the CO2 footprint of steel products through the control of their manufacturing in several plants.

As a matter of illustration, one steelmaking unit S1 may produce a slab according to an original manufacturing route MR1, said slab being then sent to a second steel manufacturing unit S2 where it is turned into a coil of galvanised steel for automotive according to a second original manufacturing route MR2. A tonnage T_{glob} of galvanized steel is defined. Maximum level of CO2 emissions Emax1 and EMax2 are defined for each unit. Calculation step 110 is performed to calculate expected level Eexp1 and Eexp2 which are then compared at 120 to the respective targets. If Eexp1 is superior to Emax1 then an optimized manufacturing route OMR₁ is defined by adjusting, for example, the amount of scrap charged to the converter and increasing the amount of blast furnace gas sent to a fermentation process. This optimized manufacturing route OMR1 has an optimized level of emissions Eoptim1 inferior or equal to Emax1. If Eexp2 is inferior to Emax2, no optimized route needs to be defined. Then the slab is produced in steelmaking S1 according to the optimized manufacturing route OMR1 and then sent to the steelmaking unit S2 where it is turned to a coil of galvanized steel according to the original manufacturing route MR2. When delivered to the customer, the tonnage T_{glob} of produced galvanized steel has then a reduced global footprint, thanks to the method according to the invention.

Steelmaking units S1 and S2 could also both produced coils of galvanised steel and their respective cumulated productions would provide the global tonnage.

As another matter of illustration, a first steelmaking plant S₁ could be a Blast Furnace—Basic Oxygen Furnace kind of plant and a second steelmaking plant S₂ could be a DRI-EAF kind of plant, those two plants having to produce a product P in a quantity T_{glob} with a defined over all expected level E_{glob} of CO₂ emissions and according to respective initial manufacturing routes MR₁ and MR₂, with respective maximum level of CO2 emissions Emaxᵢ and Emax2 defined according to local regulations. According to those manufacturing routes, steelmaking plant S1 could produce 60% of T_{glob} with an expected level of emissions Eexp1 and steelmaking plant S2 could produce remaining 40% of T_{glob} with an expected level of emissions Eexp2. However, steelmaking plant S1 must use coke produced with a coal coming from a very distant mining site which makes the expected level of emissions Eexp1 above the defined target Emax1 while Eexp2 remains below Emax2. Optimized manufacturing routes OMR1 and OMR2 are then defined, OMR1 including a reduction of coke consumption and a production of 50% of T_{glob} while OMR2 includes an increase of scrap consumption so as to produce 50% of T_{glob}. Eoptim1 and Eoptim2 are then respectively lower or equal to Eexp1 and Eexp2.

The invention allows to globally reduce carbon footprint of the steelmaking without reducing the overall production capacity.

The method can be applied to several steelmaking units belonging to a same company in order to reduce the global footprint of said company.

1-10. (canceled)

11: A method of manufacturing a given tonnage of steel products T_{glob} in at least two steelmaking units Sᵢ, the method comprising the following steps:
a. a target definition step wherein
an overall expected level E_{glob} of CO₂ emissions from all steelmaking units Sᵢ to manufacture such tonnage T_{glob} of steel products is defined,
a maximum level of CO₂ emissions Emaxᵢ is predefined for each steelmaking unit Sᵢ,
b. a calculation step wherein an expected level of CO2 emissions Eexpᵢ is calculated for each steelmaking unit Sᵢ, such calculation being done considering all CO₂ contributions linked to raw materials, energy sources and processes initially selected for manufacturing the steel products following an initial manufacturing route MRᵢ,
c. a comparison step between respective calculated expected levels Eexpᵢ and predefined targets Emaxᵢ, wherein:
i. if any or all Eexpᵢ is above its respective Emaxᵢ, modifying the final selection of any or all the raw materials, energy sources and processes to define an optimized manufacturing route OMRᵢ with optimized levels of CO2 emissions, Eoptimᵢ being lower than or equal to Emaxᵢ, and
d. a production step wherein such tonnage T_{glob} of steel products is manufactured in said steelmaking units Sᵢ according either the original manufacturing route MRᵢ or the optimized manufacturing route OMRᵢ when defined.

12: The method as recited in claim 11 wherein a first steel product is manufactured in the first steelmaking unit and then send to the second steelmaking unit to be transformed into a second steel product.

13: The method as recited in claim 11 wherein finally selected raw materials are chosen from the group consisting of coal, coke, iron ore, biomass, sintered ore, agglomerates, pellets, direct-reduced iron (DRI), scrap, mineral additions, alloying elements, oxygen and hydrogen.

14: The method as recited in claim 13 wherein the finally selected raw material are chosen from the group consisting of biomass, scrap, cold-bonded pellets, direct-reduced iron (DRI), mineral additions, alloying elements, oxygen and hydrogen.

15: The method as recited in claim 13 wherein scrap is among the finally selected raw materials and is of different type and is chosen from the group consisting of: old scrap, new scrap, prime scrap, home scrap, pit scrap, shredded, plates and structure scrap, heavy melting scrap, cast scrap, coil scrap and busheling scrap.

16: The method as recited in claim 11 wherein finally selected energy sources are chosen among renewable electricity, electricity produced by internal recycling of exhaust gas from the steel manufacturing process or by capture of heat released by products from the steel manufacturing process.

17: The method as recited in claim 11 wherein finally selected processes are chosen among direct reduction processes, hydrogen-based ironmaking, steel electrolysis, blast furnace with top-gas recycling, blast furnace with top-gas conversion, electric-arc-furnace steelmaking, converter steelmaking, scrap melting.

18: The method as recited in claim 11 further comprising a step, after step d, of establishing a certificate indicating the optimized level Eoptimᵢ of CO2 emissions associated to part or all of the tonnage T_{global} of manufactured steel products.

19: The method as recited in claim 11 further comprising a step, after step d, of:
calculating the cumulated value Σ(Eoptimᵢ) of CO2 emitted in step d) of all steelmaking units Sᵢ for manufacturing said tonnage T_{global} of steel products,
calculating the difference Δₑₘ between such cumulated value Σ(Eoptimᵢ) and the overall expected amount E_{glob} of CO2 emissions for said tonnage T_{global} of steel products as defined in step a) to determine the amount Eₙₒₜ of CO2 that was not emitted,
allocating all or part of this not-emitted amount Eₙₒₜ of CO2 to a tonnage T_{green} of steel products, T_{green} being lower than T_{global}, to calculate a reduced level of CO2 emissions for such tonnage T_{green} of steel products by reducing the expected level of CO2 emissions triggered by its manufacturing by such not-emitted amount of CO2, and
establishing a certificate indicating said reduced level of CO2 emissions associated to such tonnage T_{green} of steel products.

20: The method as recited in claim 19 wherein said reduced level of CO2 emissions associated to such tonnage T_{green} of steel products is equal to zero.
